(19) United States
(12) Patent Application Publication
(10) Pub. No.: US 2019/0308780 A1
(43) Pub. Date: Oct. 10, 2019

(54) DISCHARGE HEAD, AND LIQUID DISPENSER COMPRISING SUCH A DISCHARGE HEAD

(71) Applicant: APTAR RADOLFZELL GMBH, Radolfzell (DE)

(72) Inventors: Tobias BAUMANN, Konstanz (DE); Thomas BRUDER, Konstanz (DE)

(21) Appl. No.: 16/348,067

(22) PCT Filed: Nov. 10, 2017
(86) PCT No.: PCT/EP2017/078936

§ 371 Date: May 7, 2019

(30) Foreign Application Priority Data
Nov. 17, 2016 (EP) 16199378.7

(51) Int. Cl. B65D 47/18; B65D 47/08; B65D 47/20; B05B 11/00

(52) U.S. Cl. CPC B65D 47/18; B65D 47/0804; B05B 11/0062; B05B 11/3073; B65D 47/2031

(57) ABSTRACT

Discharge head for a liquid dispenser including a housing, a coupling device for attachment to a liquid store, a discharge opening through which liquid is dispensed and an outlet channel extending from an inlet region, pointing in the direction of the liquid store, up to the discharge opening and via which the discharge opening is supplied with liquid. A throttle device is arranged in the outlet channel and includes a throttle channel for reducing liquid pressure and/or liquid flow through the throttle device. The throttle device is designed in the form of a dynamic throttle device, in which a free cross section of the throttle channel is reduced in size with increasing pressure prevailing at the throttle device, or with greater liquid flow flowing through the throttle device.

### FIELD OF APPLICATION AND PRIOR ART

The invention relates to a discharge head for a liquid dispenser, and to a liquid dispenser with such a discharge head.

A discharge head of the type in question has a housing and a coupling device for attachment to a liquid store. It also has a discharge opening through which liquid is able to be dispensed into a surrounding atmosphere, and an outlet channel which extends from an inlet region, pointing in the direction of the liquid store, up to the discharge opening and by means of which the discharge opening is able to be supplied with liquid.

With a dispenser of the type in question and a discharge head of the type in question, it is provided that the liquid in the liquid store, or in a pressure chamber separate therefrom, is subjected to pressure in order to be conveyed by way of this pressure through the outlet channel in the direction of the discharge opening. However, according to the manner of the pressure application, it is possible for a user to influence the pressure directly and thus, in light of the application purpose, also to subject the liquid to an excessive pressure, for example by the force with which a squeeze bottle, serving as a liquid store, is compressed.

The effect of this user-dependent pressure application can then be for example that a liquid jet is released at the discharge opening, although only a small quantity of liquid for forming drops should be dispensed. Alternatively, a pressure can be generated, which leads to a spray pattern with excessively fine droplets.

In order to limit the liquid pressure and/or the liquid flow, it is possible to provide in the outlet channel a geometry which acts as a throttle, for example a channel section with a very small cross section and/or a relatively large length. Due to the friction established here, it is possible to reduce the liquid pressure/the liquid flow. However, the effect of such a throttle is then that the actuation always has to be realized by a fairly large force. This may not be a problem for some application purposes. However, specifically with application purposes in which a positionally accurate release of the liquid is desired, for example during the application of eye drops or the application with pinpoint accuracy of make-up, it is desirable that a relatively gentle actuation is enough to be able to bring about the desired discharge process.

### PROBLEM AND SOLUTION

The problem addressed by the invention is to provide a discharge head and a liquid dispenser, which, even when subjecting the liquid to low pressure, are able to release said liquid through the discharge opening in the manner as intended, but at the same time, if actuation is too intense, limit the liquid pressure and/or the liquid flow such that an intended form of release of the liquid remains possible.

For this purpose, it is provided that the discharge head has, in the outlet channel, a throttle device with a throttle channel for the reduction in the liquid pressure and/or the liquid flow of the liquid flowing through the throttle device.

According to the invention, said throttle device is designed in the form of a dynamic throttle device, in which a free cross section of the throttle channel is reduced in size with increasing pressure prevailing at the throttle device, or with greater liquid flow flowing through the throttle device.

Just like a discharge head of the type in question, a discharge head according to the invention has an outlet channel at whose end the exit opening is provided. Said outlet channel connects a liquid store of the liquid dispenser to the discharge opening such that, when the liquid in the liquid store is subjected to pressure as a whole or else a partial amount of the liquid is subjected to pressure, this is conveyed in the direction of the discharge opening and released there.

In order to avoid an excessively high pressure and/or an excessive liquid flow at the discharge opening, the stated dynamic throttle device is provided. Said dynamic throttle device has the special feature that it adapts the-flow resistance in dependence on actuation parameters. This is realized in that a free cross section of the throttle channel is reduced in size with higher pressure or greater liquid flow. Such a reduction may for example consist in that, beyond a first throttle location, a further throttle location is formed in the outlet channel by displacing a throttle surface, the free cross section of which further throttle location is less than that of the first throttle location. In particular, however, a wall of the throttle channel can undergo a displacement such that, in this way, the throttle channel reduces in size its free cross section.

In the simplest case, it is possible for the dynamic throttle device to be designed such that it normally only assumes one of two possible states, a non-throttling or barely throttling state and a more highly throttling state. A design in which the throttling effect comes into being in an, as it were, analog manner, such that, with increasing application of pressure or increasing liquid flow, a continuously increasing throttling effect is obtained, is preferable however. Although a configuration of the dynamic throttling device in which it completely closes with excessively high pressure is not ruled out, it is considered to be advantageous for the dynamic throttling device to be designed such that it never completely closes the throttling channel.

The dynamic throttle device is adapted as intended in dependence on operating parameters in each case, specifically in dependence on the prevailing pressure or on the liquid flow, wherein, according to configuration, the two stated variables are coupled to one another or in each case bring about adaptation of the dynamic throttle device. A configuration of the throttle device which, directly by pressure, leads to a reduction in size of the free cross section of the throttle channel may be provided for example if differently sized pressure application surfaces on a displaceable wall of the throttle channel ensure that increasing pressure brings about a deflection of said wall. The liquid flow can also bring about the displacement of a channel wall of the throttle channel if an identical total pressure prevails on both sides of said wall, since the increased liquid speed in the throttle channel, in accordance with Bernoulli's principle, leads to a lower static pressure there, this in turn being able to be used to narrow the throttle channel.

The throttle channel is delimited, at least in sections, by an inner side of a channel wall whose position is able to be varied by displacement or deformation.

In the case of the throttle channel being varied by displacement of a channel wall, it is preferably provided that said channel wall is inherently rigid and part of a throttle component which is displaced as a whole. This will be discussed in more detail below.

In the case of the throttle channel being delimited by a deformable channel wall, it is provided that a deformable and preferably elastic component, which is subsequently thereby able to return to its initial position, is used in order to bring about a variable cross section of the throttle channel.

An outer side of the channel wall, which faces away from the inner side, is able to be connected in a communicating manner to an inlet of the throttle channel such that, when the liquid is subjected to pressure for the purpose of discharge, an identical pressure increase is realized at the inlet of the throttle channel and at the outer side of the channel wall.

A configuration in which an identical total pressure is established on both sides of the channel wall is advantageous since the cross section of the throttle channel is made to vary not by the pressure application of the liquid as such, but rather only by the increase in the dynamic pressure and the drop in the static pressure in the throttle channel. The dynamic pressure arises owing to the speed of the liquid flow in the throttle channel. Since it is normally the aim to limit the liquid flow in a configuration according to the invention of a discharge head, a solution in which it is also the case that the liquid flow and its speed directly constitute that variable which leads to narrowing of the throttle channel and thereby to an increase in the friction with respect to the walls and within the liquid and consequently to a reduction in the liquid flow is advantageous. To a certain extent, the liquid flow itself is thereby directly limited.

The positionally variable channel wall may be part of a planar and preferably deformable wall plate. A positionally fixed channel wall may be provided opposite said channel wall, the latter being at least partially positionally variable with respect to the housing, wherein the positionally variable channel wall and the positionally fixed channel wall define the throttle channel between them.

This design has turned out to be very simple and reliable. In this case, the throttle channel is formed by a gap between the non-deformed planar wall plate and the channel wall which is positionally fixed with respect to the housing. The planar and preferably deformable wall plate is preferably fastened in a manner positionally fixed with respect to the positionally fixed channel wall in a fastening region and projects over said positionally fixed channel wall so as to form the gap. It is advantageous in particular if the positionally fixed channel wall furthermore has at least one aperture, which constitutes the end of the throttle channel, as it were, and into which the liquid which has passed through the throttle channel flows. A particularly simple possibility for fastening the planar and preferably deformable wall plate is for this to be provided with an aperture, which is pushed onto a housing-side fastening pin and is fastened, for example snap-fitted, there.

The discharge head may have multiple throttle channels, which are connected in parallel with respect to one another. The wall plate may in this case be provided as a common wall plate, which delimits the at least two throttle channels in sections.

Although one throttle channel is naturally sufficient for achieving the desired purpose, it can advantageously and, in terms of construction, very easily be possible to provide multiple throttle channels which are connected in parallel. Parallel connection is to be understood as meaning that the liquid has to pass through only one of these throttle channels connected in parallel. The arrangement in which a common wall plate delimits both throttle channels in sections leads to a reduction of components and is also very simple to achieve by a point- or line-symmetrical configuration. In this regard, the wall plate can be fastened between the throttle channels in the region of a web, and deform as intended on both sides of said web to bring about narrowing of the two throttle channels provided there. Depending on the specific application purpose, for the purpose of adapting the throttling behavior, it can also be expedient for more than two throttle channels, in particular four throttle channels, to be provided. At least one elevation may be provided on the housing wall or the wall plate, in the region of which the housing wall and the wall plate bear against one another.

A gap which constitutes the throttle channel is defined by the housing wall and the wall plate in a manner already stated. Said gap is additionally delimited by the stated elevations or the edges thereof. The housing wall and the wall plate bear against one another in the region of the elevations, wherein it is advantageous in particular if the elevations are provided on sides of the housing wall since it is then possible for the deformable wall plate to be designed as a wall plate of elevation-free, planar form, which is thus inexpensive to produce.

The elevations and in particular the edges of these elevations, which at the same time form the edges of the throttle channel, may be used in a simple manner in order to influence the tendency of the wall plate for throttling deformation. If, for example, a rectilinear web- like elevation is provided, then, for the purpose of deforming the wall plate fastened in the region of this elevation, it is necessary for the wall plate to be bent in, following the web-like elevation, merely once. However, if there are provided elevations whose edges pointing in the direction of the throttle channel include an angle of less than 180°, for example an angle of approximately 90°, then it is necessary for the wall plate to bend in along two non-parallel lines for the purpose of the deformation, this requiring a greater degree of force application. It is in particular also possible for the shape of the elevations to be used in order to adapt otherwise structurally identical discharge heads to different liquids and the specific properties thereof or to be able to influence the maximum discharge pressure/discharge liquid flow in the light of the field of application.

As an alternative to the design described, in which the throttle channel is delimited by a positionally fixed and preferably rigid wall and a positionally variable wall, it may also be provided that the discharge head has a throttle component composed of an elastically deformable material as part of the throttle device. Said throttle component has an aperture which is surrounded by a deformation region and which forms the throttle channel.

The throttle component additionally preferably has at least one pressure application surface, against which, during operation, the liquid bears upstream of the throttle channel and by way of whose pressure application the deformation region is deformed and a free cross section of the throttle channel is able to be reduced in size.

With this alternative design, it is provided that the throttle channel is provided in the form of an aperture, which is surrounded in an encircling manner, at a throttle component which is deformable as a whole, wherein the regions surrounding this aperture, that is to say the throttle channel, form the deformation region and are able to be deformed by pressure application, or a liquid flow, such that the free cross section of the throttle channel is varied.

Since, with such a design, the throttle channel is defined by one component alone, it is possible to achieve very low variation in the characteristics of structurally identical discharge heads. By contrast to a design in which the throttle channel is formed by multiple components, with this design, there is barely any dependence on a particular assembly accuracy.

Added to this is the fact that the assembly is very simple owing to the configuration of the throttle channel from merely one component.

The throttle component may have an elevation which is bulged in the upstream direction and in which the throttle channel is provided. In this way, it is achieved that the narrowing, provided as desired, of the throttle channel is reliably established if the liquid pressure is applied to the elevation from different sides. The throttle channel preferably penetrates the elevation at the most elevated point thereof.

The throttle component may have an encircling edge region on the outside, which is integrally connected to the deformation region.

In the region of said edge, the elastic throttle component may be fastened to a rigid housing section of the housing by way of a snap-action connection or in particular an integral formation.

The fastening of the throttle component to a housing section of the housing of the discharge head is advantageous since, in this way, a pre-assembly unit which, even when handled as a bulk good, does not run the risk of damage to the elastic throttle component is provided. Said throttle component is preferably set back with respect to walls of the housing such that, handled as a bulk good, it is not damaged by other discharge heads of the bulk good. This has turned out to be advantageous in practice since otherwise there is the risk that the throttle component no longer responds in a throttling manner in the desired way after being damaged as a bulk good.

Of particular advantage is the integral formation in which, preferably by two-component injection molding, the stated rigid housing section and the elastic throttle component are produced integrally from different materials. The number of the components to be joined during the course of an assembly can be reduced in this way. Moreover, a highly precise and permanent positioning of the throttle component relative to the housing is consequently ensured.

The edge region may be arranged such that, when the liquid store is coupled, it seals off the liquid store with respect to the housing. As a result of this use of the edge region of the throttle component as a seal between the discharge head and the liquid store, it is possible to dispense with a separate component therefor. The discharge head can therefore be produced with very few components and correspondingly little effort in terms of assembly.

In one particular configuration, the throttle channel may have at least one closure region and at least one free region, which regions form the cross section of the throttle channel jointly and so as to merge into one another. In the closure region, opposite edges of the throttle channel come to bear against one another as a result of the pressure application surface being subjected to force. The free region is delimited by an edge arrangement which does not lead to closure of the free region even when the pressure application surface is subjected to force.

The stated design accordingly provides that the throttle channel has a cross-sectional area which has a pressure- or liquid flow-dependent sub-region, the closure region, which closes with high pressure or with a large liquid flow. Moreover, however, there is also provided a free region which, even in the case of the greatest pressures and liquid flows to be assumed during real operation, remains open.

It is thus ensured that, even in the case of high pressures, a complete closure of the throttle channel does not take place. This corresponds to the desire for a discharge in the case of excessively intense application of force not to be prevented but to be dampened to the extent that the desired discharge pattern is established.

As a result of the joint realization of the closure region and the free region as part of the cross section of the same throttle channel, it is also achieved that, after narrowing of the throttle channel by closure of the closure region, the tendency of the closure region to re-open after the closing pressure has subsided is promoted. This is advantageous specifically in view of the fact that it is also intended for it to be possible for tacky material to be discharged by means of the discharge head according to the invention.

The design in sections of the throttle channel as a closure region or as a free region can be determined by the selection of the geometry. In this regard, a slot- shaped section of the cross section of the throttle channel is suitable for complete closure and thus to constitute a closure region. However, a circular or polygonal portion of the throttle channel does not completely close, even with high pressures, and thus constitutes a free region.

Although it is considered to be advantageous to design a combined throttle channel having such a closure region and a free region, also conceivable is a design in which two channels connected in parallel jointly form a throttle channel arrangement, wherein one of these channels has a free region while the other channel completely closes in a pressure- or liquid flow-dependent manner. Such a design can also be expedient in particular in the case of liquids which do not promote the lasting adhesion of opposite edges or walls of the throttle channel.

As a alternative to the design described, in which the throttle channel is preferably delimited in sections by at least one wall which varies in shape, it is provided in a further variant that the throttle channel is delimited by two rigid channel walls, wherein one of the channel walls is provided as a positionally variable channel wall on a positionally variable throttle component.

With this design, the throttle channel is delimited by rigid walls which are movable as a whole relative to one another. At least one of these walls is able to be deflected, preferably counter to the force of a restoring spring, wherein the free cross section of the throttle channel is reduced in size by way of said deflection.

Said positionally variable throttle component is preferably guided with respect to the housing by means of a guide, wherein said guide may be formed in particular by two sleeves which are slid telescopically one inside the other. Said spring force is preferably generated by a spring device which, with a particularly advantageous design, is arranged in the free space formed by the sleeves.

It is of particular advantage if the throttle component is designed such that, and/or is attached to the housing such that, pressure application surfaces on the throttle component which are active for displacement cause, with identical pressure on all pressure application surfaces, the throttle component to be subjected to force in a direction in which the free cross section of the throttle channel is reduced in size. This means that the static pressure alone, which is applied for the purpose of discharge, is able to displace the throttle component in terms of narrowing the throttle channel.

Preferably, the discharge head has, in the outlet channel downstream of the throttle device, an outlet valve which opens in dependence on the positive pressure prevailing upstream.

Such a valve leads to the risk of egress from the dispenser being reduced. However, since it is in particular intended for a drop dispenser based on a discharge head according to the invention to be realizable, it is particularly advantageous if the valve already opens at a low positive pressure of, for example, 0.3 bar.

The outlet valve preferably closes automatically in a pressure interval between a defined inlet-side negative pressure and an inlet-side positive pressure and opens when the defined negative pressure is exceeded and when the defined positive pressure is exceeded. Consequently, such a valve opens both with negative pressure and with positive pressure. This is the prerequisite for simultaneous use of the outlet channel as an aeration channel for the liquid store. This is advantageous in terms of simple construction. Moreover, a particular advantage in using the outlet channel jointly as an aeration channel too is that the throttle channel is able to be widened again by the incoming air after a discharge process has ended.

This is also supported in that such bidirectional behavior also makes it possible for the negative pressure prevailing in the liquid store after the dispensing to suck the liquid back from the outlet channel too, with the result that drying-on in the region of the outlet channel beyond the valve is prevented.

The outlet valve is preferably formed from an elastic material and has a bulge which is directed upstream and in which a valve opening, which is able to be closed by valve lips, is provided such that, with increasing inlet- side positive pressure, the valve lips are increasingly pressed against one another by the positive pressure up to the attainment of an inlet-side limit pressure for positive pressure.

The discharge head is preferably designed for the formation of drops, wherein the throttle device is designed for a limitation of the liquid flow, which leads to the formation of single drops, and not to the formation of a liquid jet, at the discharge opening.

In the case of such drop dispensers in particular, prevention of excessive liquid flow and/or excessive discharge pressure is relevant, since this counteracts drop formation and can lead to an unintended jet at the discharge opening. The throttle device is preferably adapted to the configuration of a drop formation surface, arranged beyond the outlet opening, such that the liquid flow at the discharge opening is not sufficient to allow a continuous separation of the liquid flow, that is to say a jet.

Preferably, the housing of the discharge head comprises a first, integral base component, which comprises the coupling device for attachment to the liquid store, and a second, integral applicator component, which has the discharge opening and is penetrated by the liquid channel and is fastened to the base component.

The stated design with merely two components at the housing is very inexpensive owing to the simplicity thereof. Moreover, the two housing components, the base component and the applicator component, make it possible for the stated outlet value to be positionally fixed in a simple manner. If the throttle component is, in the manner outlined above, designed in the form of an elastic component which is formed integrally with a housing section, in particular from the base component, then it is possible for a complete discharge head to be assembled from merely three components to be assembled.

Likewise provided for the solution of the invention is a liquid dispenser for dispensing liquid, in particular for dispensing cosmetic or pharmaceutical liquids, which has a discharge head with an outlet opening for dispensing of liquid into a surrounding atmosphere, and which has a liquid store, which is connected to a housing of the discharge head by way of a detachable coupling device or an integral formation.

In this case, the discharge head is designed as claimed in one of the preceding claims.

In this case, the liquid dispenser is preferably designed in the form of a drop dispenser. There is thus provided beyond the discharge channel a drop formation surface, preferably in the form of a spherical cap, at which the liquid is gathered before it is detached in drop form. Said drop formation surface, the throttle device and the liquid in the dispenser are preferably matched to one another such that, even with a high actuation force applied to the squeeze bottle of 100 newtons, a liquid jet does not form at the discharge opening.

The liquid store is preferably designed in the form of a squeeze bottle or tube. With such a design of the liquid store in the form of a squeeze bottle or tube in particular, there is the risk that excessively intense actuation is realized by the user, and so the dynamic throttle device which has been described here is particularly helpful for preventing said excessively intense actuation from adversely influencing the discharge pattern.

The inner volume of the liquid dispenser is preferably less than 300 ml, less than 100 ml, or, even, less than 50 ml. These are typical sizes of liquid stores for holding pharmaceutical or cosmetic liquids.

The liquid store is preferably filled with a cosmetic or pharmaceutical liquid. As pharmaceutical liquids, liquids carrying preservatives are possible in particular, since it is considered to be advantageous if, with a discharge head according to the invention, the aeration is realized through the outlet channel, so that it is difficult here for air filtering to be realized in a structural sense. In the area of cosmetic liquids, make-up products and creams, such as for example anti-wrinkle cream and oils, which are in particular intended to be discharged. In particular, so-called filler or concealer liquids, which serve for filling or covering relatively small wrinkles, can be dispensed well with a discharge head according to the invention.

### BRIEF DESCRIPTION OF THE DRAWINGS

Further advantages and aspects of the invention will emerge from the claims and from the following description of preferred exemplary embodiments of the invention, which are discussed below on the basis of the figures.

FIG. 1 shows, in an overall illustration from the outside, a liquid dispenser according to the invention with a discharge head according to the invention.

FIG. 2 shows, in a sectioned illustration, a first exemplary embodiment of a liquid dispenser according to the invention.

FIG. 3 shows, in an exploded illustration, the sub-components of the discharge head of the first exemplary embodiment.

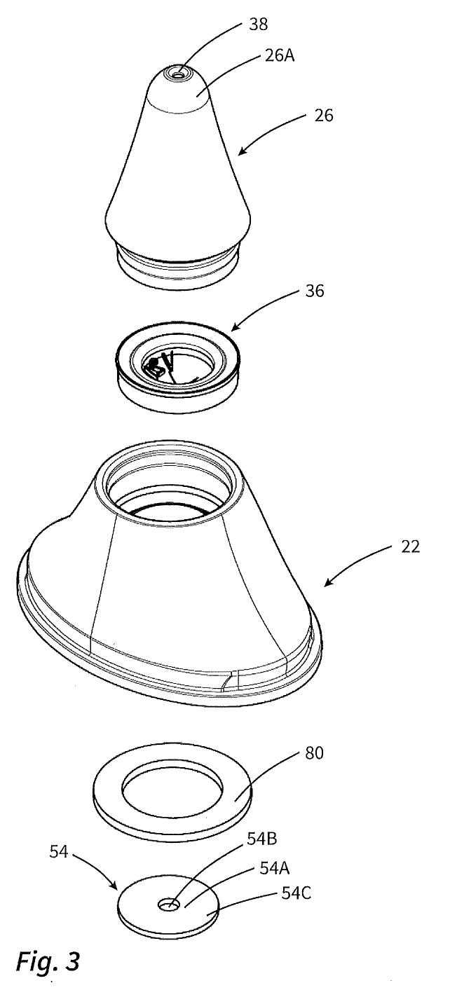

FIGS. 4A and 4B show the inner side of the discharge head as per FIG. 3 with separated and attached flexible wall plate.

FIGS. 5A and 5B show an alternative design of the discharge head, which has a slightly different geometry in the region of the throttle channel.

FIG. 6 shows, in a sectioned illustration, a second exemplary embodiment of a liquid dispenser according to the invention.

FIG. 7 shows, in an exploded illustration, the sub-components of the discharge head of the second exemplary embodiment.

FIG. 8 shows, in a separate illustration, the throttle component of the second exemplary embodiment.

FIG. 9 shows, in a perspective from below, different variants of the throttle component for the exemplary embodiment in FIGS. 6 to 8.

FIG. 10 shows, in a sectioned illustration, a third exemplary embodiment of a liquid dispenser according to the invention.

FIGS. 11A and 11B show the throttle device of the exemplary embodiment in FIG. 10 with different states of the throttle channel.

### DETAILED DESCRIPTION OF THE EXEMPLARY EMBODIMENTS

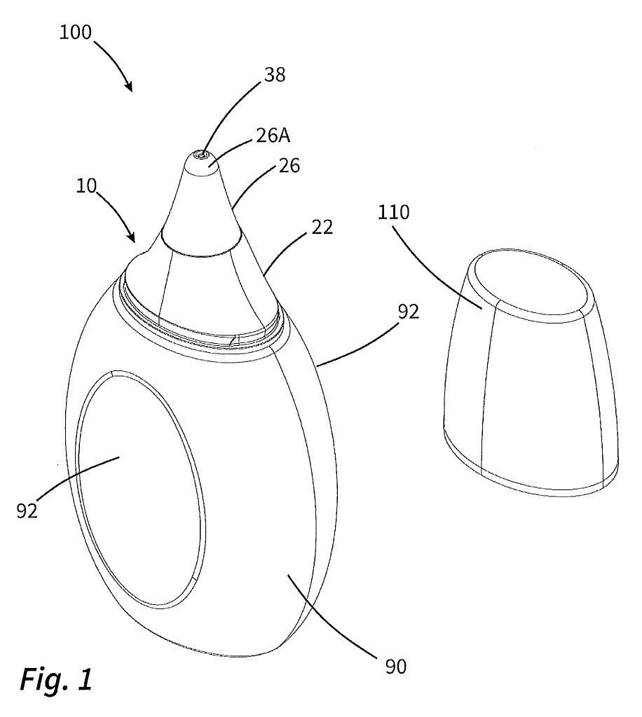

FIG. 1 shows a liquid dispenser 100 according to the invention, which is designed in the manner of a drop dispenser.

Said liquid dispenser 100 has a liquid store 90, which is designed in the form of a squeeze bottle, and a discharge head 10 mounted thereon, at which a discharge opening 38 is provided. To close the liquid dispenser, a cap 110 is provided.

The liquid dispenser serves for releasing, in drop form, drops, for example of cosmetic liquids such as oils, make-up, filler or the like. In this case, for actuation as intended, the entire dispenser is positioned more or less upside down, with the discharge opening 38 pointing downward, and, in this position, the liquid store 90 is, on opposite sides in the region of actuation surfaces 92, subjected to force and compressed such that the liquid contained in the liquid store is subjected to pressure and is conveyed to the discharge opening 38. Here, the liquid is gathered at a drop formation surface 26A, which surrounds the discharge opening 38, and, as intended, is detached in the form of individual drops.

The technical design, discussed below, of the discharge head 10 serves the purpose of ensuring both that pressing the squeeze bottle only lightly is enough for drop release drop, and that, also, actuating, or compressing, the liquid store 90 intensely does not lead to liquid being released in the form of a liquid jet.

For this purpose the following exemplary embodiments are described by way of example:

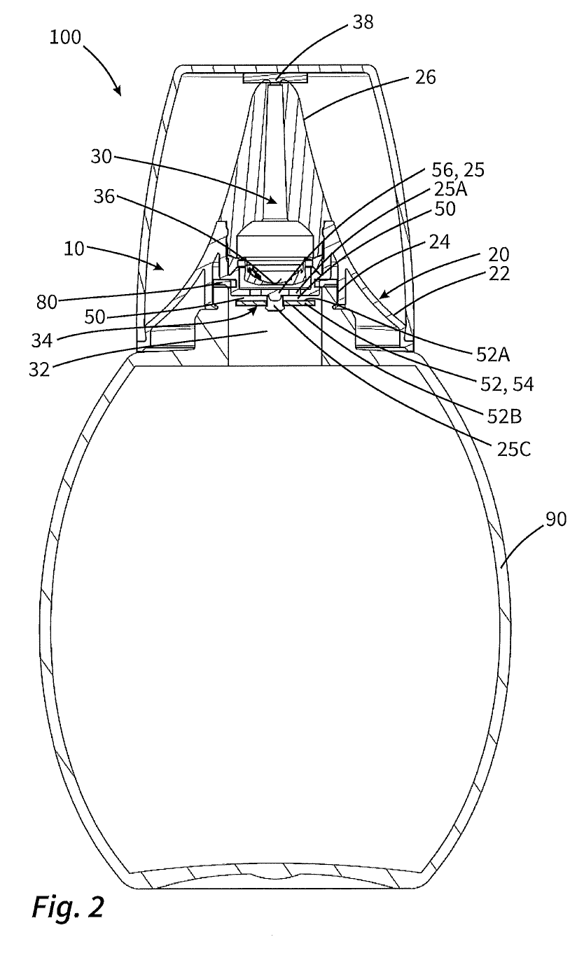

Referring to the configuration illustrated as a sectional illustration in FIG. 2, in connection with a first exemplary embodiment, it can be seen that the outlet channel 30 extends from an inlet region 32, which is adjacent to the interior of the liquid store 90, through two throttle channels 50 of a throttle device 34 and through apertures 25A of the housing 20, up to the region of an outlet valve 36, and further up to the discharge opening 38.

Here, the outlet valve 36 is designed such that it is able to open both in the outlet direction and in the inlet direction with positive pressure and negative pressure, respectively, in the liquid store, so that, following discharge, the outlet channel 30 can also serve as an aeration channel in the reverse direction and allows the liquid to be sucked back from the outlet channel 30. The outlet valve 36 closes if neither positive pressure nor negative pressure in the liquid store 90 with respect to the surroundings prevails, or the positive pressure or the negative pressure does not exceed a limit value. In this way, it is ensured that the risk of inadvertent egress when handling the liquid dispenser 100 is low.

The discharge head 10 has a very simple construction. Beyond the design, discussed in more detail below, of the throttle device 34, the discharge head 10 is constructed from merely three constituent parts, namely from a two-part housing 20, having a base component 22 and an applicator component 26, and from a fastening ring, fixed between said two components, of the outlet valve 36, which valve is designed in the form of a one-piece elastic component. In the exemplary embodiment, there is additionally provided a sealing ring 80 for sealing off the discharge head 10 with respect to the liquid store 90.

The actual special feature of the dispenser lies in the throttle device 34. Said throttle device is, as already stated, intended to prevent a liquid jet from exiting through the discharge opening 38 if the liquid store 90, designed in the form of a squeeze bottle, is actuated too intensely. For this purpose, the throttle device 34 provided in this first exemplary embodiment comprises a separating wall 25, which belongs to the base component 22 and at the same time constitutes a first positionally fixed channel wall 56 of the throttle channel 50. The second, opposite channel wall is formed by the inner side 52A of an elastically deformable wall plate 54, the latter being clipped onto the base component 22 in the region of a fastening pin 25C.

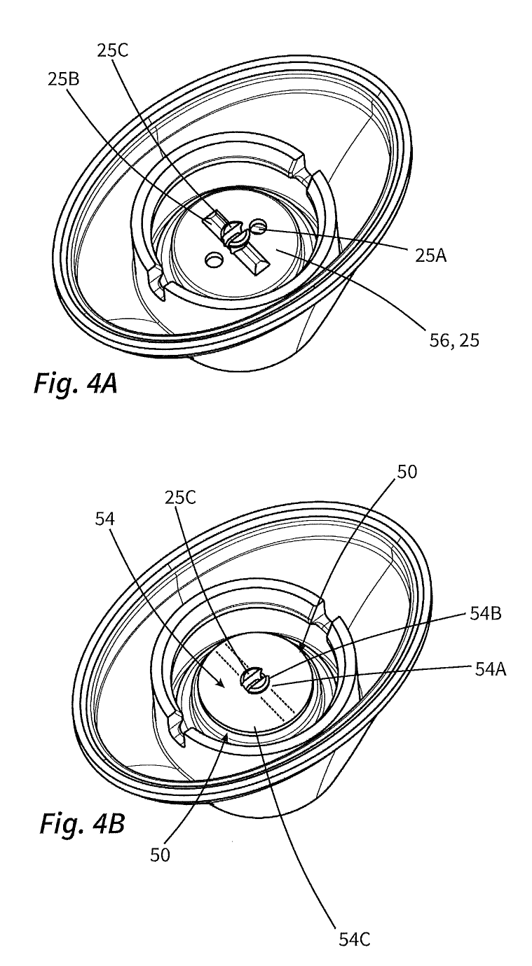

This will be discussed more precisely referring to FIGS. 4A and 4B, which show the base component 22 without and with fastened wall plate 54.

On the basis of FIG. 4A, it can be seen that the housing wall 25 is penetrated by two apertures 25A. It can further be seen in FIG. 4A that, in the region of the fastening pin 25C, a bar-like elongate elevation is provided on the separating wall 25 on both sides of the fastening pin 25C. Said elevation separates two throttle channels 50 which are formed by fastening the wall plate 54 to the fastening pin 25C in the manner shown in FIG. 4B.

Again referring to FIG. 2, the functioning is as follows:

Starting from the position in FIG. 2, in which the discharge opening 38 points upward, the liquid dispenser 100 is positioned upside-down. There is as yet no risk of liquid discharge as a result of this alone, since the outlet valve 36 is designed not to open as a result of the weight force of the liquid in the liquid store alone. Only when the liquid store 90, which is designed in the form of a squeeze bottle, is compressed does liquid flow from the inlet region 32 into the in each case approximately semi-circular throttle channels 50 in the direction of the apertures 25A, through which the liquid then passes into the region of the outlet valve 36 and further to the discharge opening 38.

If the user then presses on the liquid store 90 in a highly intense manner, then the pressure which acts on the wall plate 54 is also increased. However, said pressure is increased on both sides of the wall plate, and so the pressure increase as such does not yet lead to a relevant deformation of the throttle channels 50. However, if the liquid, under the influence of said pressure, then flows more quickly through the throttle channels 50, then a dynamic pressure is generated here in accordance with Bernouilli's principle. This leads to a force acting on the wall plate 54 which, referring to FIG. 4B, allows the wall plate to bend in slightly in the region of the web, the corresponding bend lines being indicated by dashed lines in said figure. In relation to the perspective in FIG. 2, this bending-in is realized upwardly, with the result that the throttle channels 50 are narrowed. This in turn brings about an increased friction and an energy loss in the liquid, which in turn leads to a reduction in the liquid flow. Instead of the increased pressure thereby resulting in a jet-like discharge, it impedes itself, as it were, so that, despite the increased actuation force, a discharge in drop form is made possible as before.

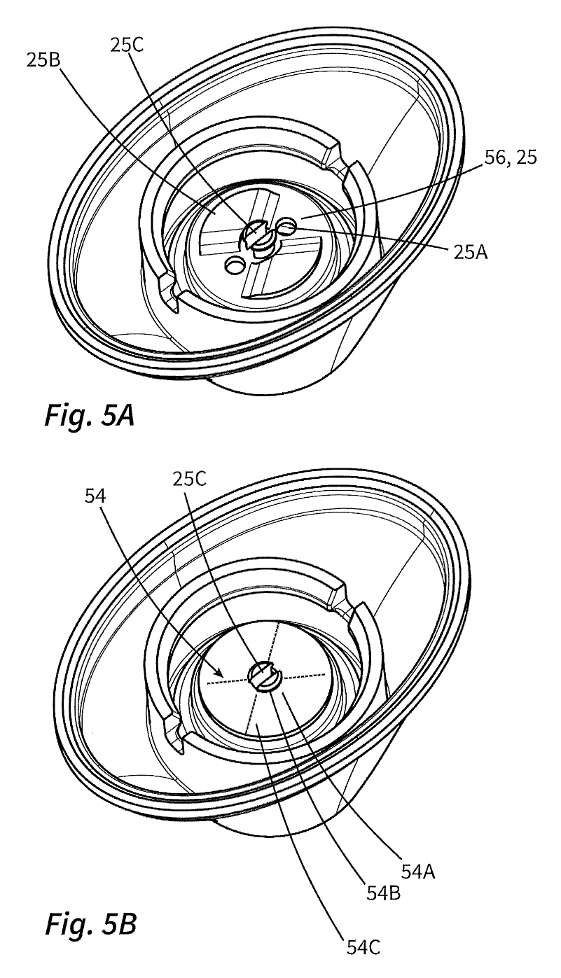

The configuration in FIGS. 5A and 5B is largely similar to that in FIGS. 4A and 4B. The only difference is that, in the case of the design in FIGS. 5A and 5B, the elevations 25B have a different shape and are not, as shown in FIG. 4A, only of elongate, bar-like form. Instead, the elevations have approximately the shape of a quadrant, with the result that the lines illustrated in FIG. 5B, along which the wall plate 54 is deformed as intended, are not in alignment with one another. The effect of this is that the narrowing of the throttle channel takes place under different boundary conditions than in the configuration in FIGS. 4A and 4B. In this manner, it is possible for the liquid dispenser 100 to be adapted for different liquids with a relatively small adaptation.

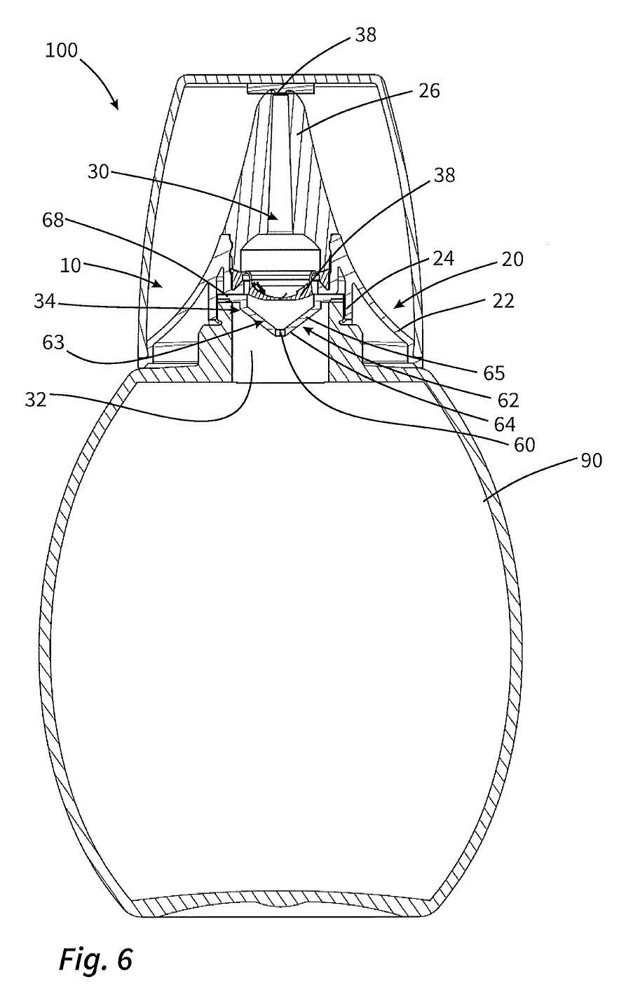

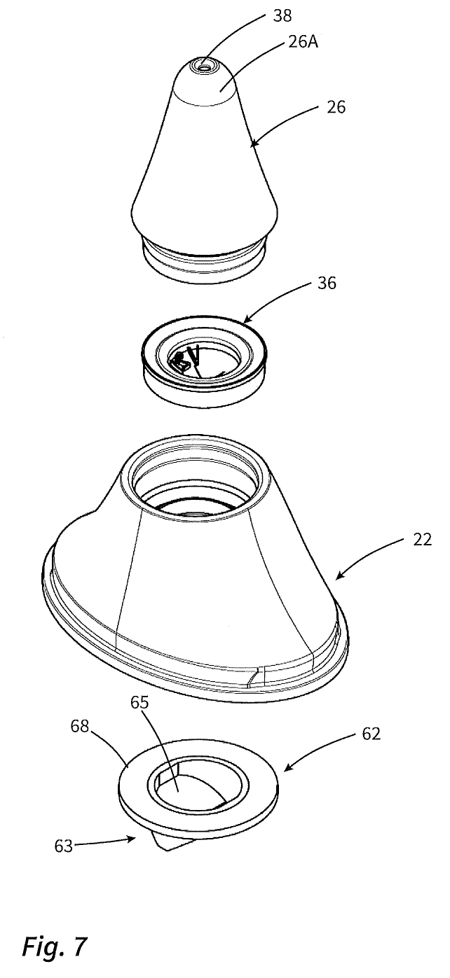

In the configuration as per FIGS. 6 to 8, the throttle device 34 is designed differently.

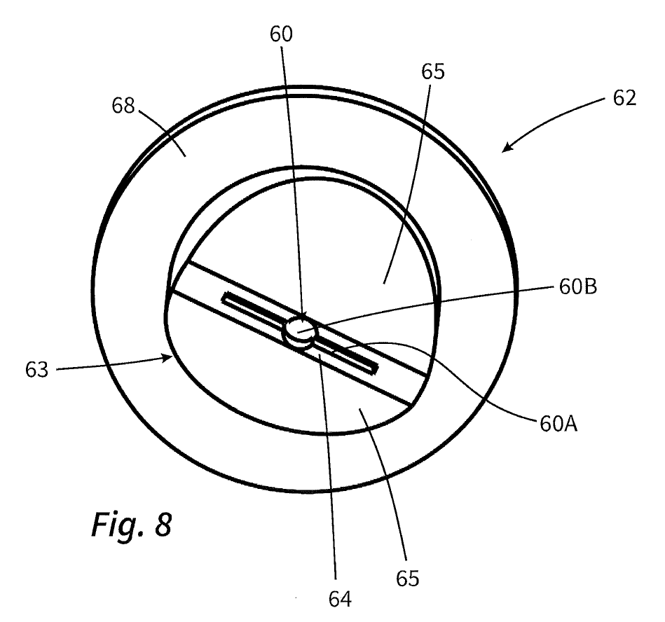

The throttle device 34 of this embodiment has a throttle component 62 which is elastic as a whole and which is penetrated by the throttle channel 60. Referring to FIG. 8, which displays the throttle component separately, it can be seen that the throttle component 62 has a planar edge region 68, above which an elevation 63 pointing in the direction of the liquid store is raised centrally. The throttle channel 60 penetrates said elevation 63 and is surrounded by a deformation region 64, which deforms as intended. Provided on the elevation are two pressure application surfaces 65 which, when the liquid is discharged, are subjected to pressure by the latter and, in this way, bring about a deformation of the throttle channel 60.

As can likewise be seen in FIG. 8, the throttle channel 60 has a circular free region 60B and slot-like closure regions 60A.

This design is selected so that, when pressure is applied, the throttle channel 60 is not completely closed.

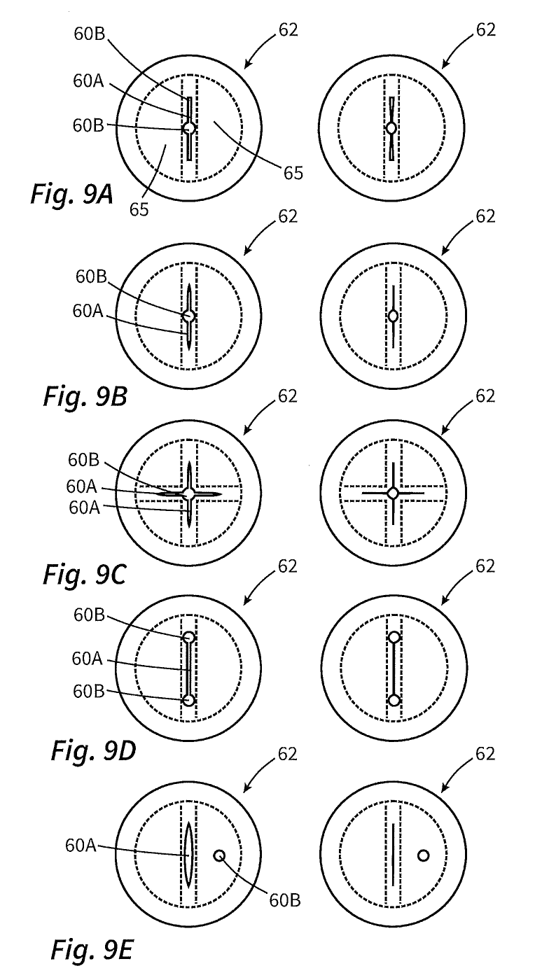

Referring to FIG. 9A, it can be seen that, even with a positive pressure prevailing at the pressure application surfaces 65, only the closure regions 64A are completely closed, while, owing to the shape of the edges, the central circular free region 60B and free regions provided at the ends of the slots remain open. This prevents an excessively intense pressure from causing the discharge to stop completely when actuating the liquid dispenser 100.

FIGS. 9B to 9D show alternative designs in this respect.

In the configuration as per FIG. 9B, the slot- shaped sub-regions of the throttle channel 60 are shaped such that they permit a complete closure.

In the case of the configuration in FIG. 9C, a cross-shaped slot formation is provided, wherein these slots also completely close when pressure is applied.

In the case of the configuration in FIG. 9D, circular free regions form the ends of the slot.

In all of these configurations, it is in each case provided that free regions 60B and closure regions 60A are part of the same throttle channel 60. This is expedient in particular for liquids which have a tendency to promote adhesion, since the free region remaining permanently open promotes the tendency for the closure regions also to be released from one another again after the discharge process has ended.

However, as the configuration in FIG. 9E shows, this is not the only option. With this last design of an elastic throttle component, the free region 60B and the closure region 60A are provided in the throttle component 62 in a manner separate from one another.

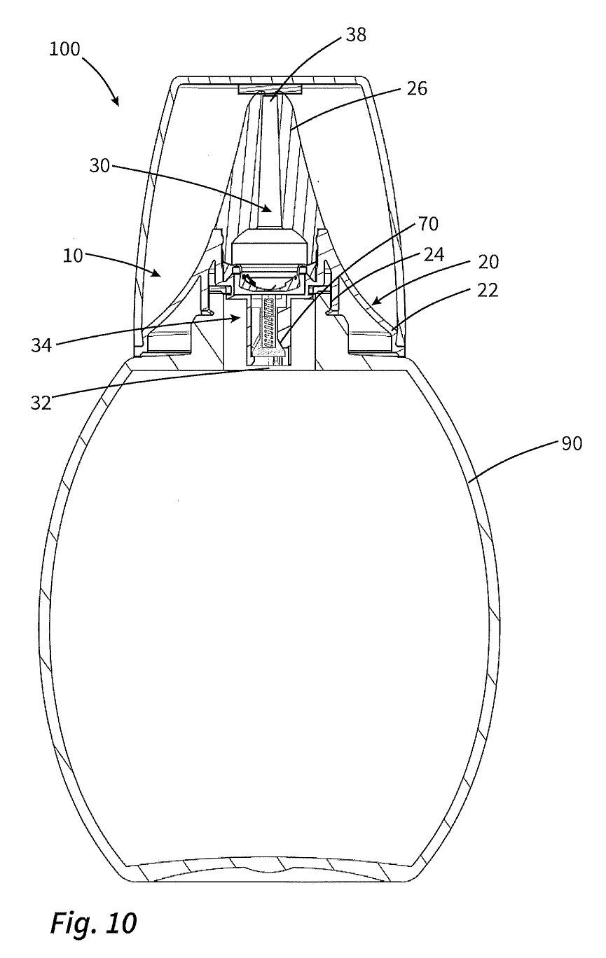

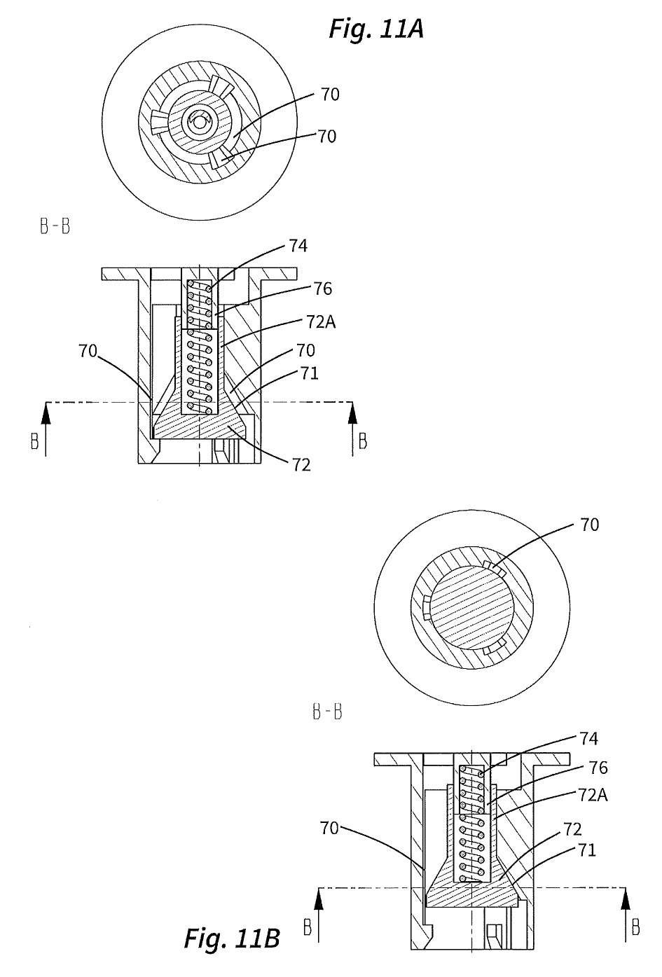

FIG. 10 and FIGS. 11A and 11B show a third configuration.

Referring to FIGS. 11A and 11B, it can be seen that, here, the throttle channel 70 is adjacent to a displaceable closure body 72, which is subjected to force in the direction of the end position in FIG. 11A via a spring 74 in a sleeve structure 76, 72A. If then a positive pressure is built up in the liquid store 90, then said positive pressure acts on the throttle body 72 on all sides. Owing to the larger effective pressure application surface for application of pressure in the upward direction, the pressure prevailing on all sides acts such that a force acts on the throttle body 72 that, in relation to the perspective in FIGS. 11A and 11B, displaces said body upward.

In this way, the throttle channel 70 is reduced in size with regard to its cross section and ultimately completely closed. However, the liquid can nevertheless still partially flow past the throttle body 72, with the result that drop formation is still possible.

1. A discharge head for a liquid dispenser, with the following features:
a. the discharge head has a housing, and
b. the discharge head has a coupling device for attachment to a liquid store, and
c. the discharge head has a discharge opening through which liquid is able to be dispensed into a surrounding atmosphere, and
d. the discharge head has an outlet channel which extends from an inlet region, pointing in the direction of the liquid store, up to the discharge opening and by means of which the discharge opening is able to be supplied with liquid, and
e. the discharge head has, in the outlet channel, a throttle device with a throttle channel for the reduction in the liquid pressure and/or the liquid flow of the liquid flowing through the throttle device, and
f. the throttle device is designed in the form of a dynamic throttle device, in which a free cross section of the throttle channel is reduced in size with increasing pressure prevailing at the throttle device, or with greater liquid flow flowing through the throttle device, and
g. the throttle channel is delimited, at least in sections, by an inner side of a channel wall whose position is able to be varied by displacement or deformation.

2. The discharge head as claimed in claim 1, with the following additional feature:
a. an outer side of the channel wall, which faces away from the inner side, is connected in a communicating manner to an inlet of the throttle channel such that, when the liquid is subjected to pressure for the purpose of discharge, an identical pressure increase is realized at the inlet of the throttle channel and at the outer side of the channel wall.

3. The discharge head as claimed in claim 1, with the following additional features:
a. the positionally variable channel wall is part of a planar wall plate, and
b. a positionally fixed channel wall is provided opposite the positionally variable channel wall, wherein the positionally variable channel wall and the positionally fixed channel wall define the throttle channel between them.

4. The discharge head as claimed in claim 3, with the following additional feature:
a. the positionally fixed channel wall is formed by a housing wall of the housing, and
b. the wall plate is, with a fastening region, arranged positionally fixed with respect to the housing wall and, with a deformable section, projects over the throttle channel in a manner approximately parallel to the positionally fixed channel wall.

5. The discharge head as claimed in claim 3, with the following additional features:
a. the discharge head has at least two throttle channels, which are connected in parallel with respect to one another in terms of flow, and
b. the wall plate is provided as a common wall plate, which delimits the at least two throttle channels in sections.

6. The discharge head as claimed in claim 1, with the following feature:
a. at least one aperture, into which the throttle channel opens, is provided in the housing wall forming the positionally fixed channel wall.

7. The discharge head as claimed in claim 1, with the following feature:
a. the wall plate has a fastening opening in the fastening region, which is snapped onto a housing-side fastening pin.

8. The discharge head as claimed in claim 1, with the following feature:
a. at least one elevation is provided on the housing wall or the wall plate, in the region of which the housing wall and the wall plate bear against one another.

9. The discharge head as claimed in claim 1, with the following additional features:
a. the discharge head has a throttle component composed of an elastically deformable material as part of the throttle device, and
b. the throttle component has an aperture which is surrounded by a deformation region and which forms the throttle channel, and
c. the throttle component has at least one pressure application surface, against which, during operation, the liquid bears upstream of the throttle channel and by way of whose pressure application the deformation region is deformed and a free cross section of the throttle channel is able to be reduced in size.

10. The discharge head as claimed in claim 9, with the following additional feature:
a. the throttle component has an elevation which is bulged in the upstream direction and in which the throttle channel is provided.

11. The discharge head as claimed in claim 9, with the following additional feature:
a. the throttle component has an encircling edge region on the outside, which is integrally connected to the deformation region and in the region of which the elastic throttle component is fastened to a rigid housing section of the housing by way of a snap-action connection or an integral formation.

12. The discharge head as claimed in claim 9, with the following additional feature:
a. the throttle component has an encircling edge region on the outside, which is integrally connected to the deformation region and is arranged such that, when the liquid store is coupled, it seals off the liquid store with respect to the housing.

13. The discharge head as claimed in claim 9, with the following additional features:
a. the throttle channel has at least one closure region, in the region of which opposite edges of the throttle channel come to bear against one another as a result of the pressure application surface being subjected to force, and
b. the throttle channel has at least one free region, which is delimited by an edge arrangement which does not lead to closure of the free region even when the pressure application surface is subjected to force.

14. The discharge head as claimed in claim 1, with the following additional feature:
a. the throttle channel is delimited by two rigid channel walls, wherein one of the channel walls is provided as a positionally variable channel wall on a positionally variable throttle component.

15. The discharge head as claimed in claim 14, with the following additional feature:
a. the positionally variable throttle component is mounted so as to be movable, in particular linearly movable, with respect to the housing by means of a guide, preferably a linear guide.

16. The discharge head as claimed in claim 14, with the following additional feature:
a. a spring device by means of which the throttle component is permanently subjected to force in a direction of enlargement of the free cross section of the throttle channel is provided between the housing and the throttle component.

17. The discharge head as claimed in claim 14, with the following additional feature:
a. the throttle component is designed such that, and/or is attached to the housing such that, pressure application surfaces on the throttle component which are active for displacement cause, with identical pressure on all pressure application surfaces, the throttle component to be subjected to force in a direction in which the free cross section of the throttle channel is reduced in size.

18. The discharge head as claimed in claim 1, with the following additional feature:
a. the discharge head has, in the outlet channel downstream of the throttle device, an outlet valve which opens in dependence on the positive pressure prevailing upstream.

19. The discharge head as claimed in claim 18, with the following additional feature:
a. the outlet valve closes automatically in a pressure interval between a defined inlet-side negative pressure and an inlet-side positive pressure and opens when the defined negative pressure is exceeded and when the defined positive pressure is exceeded.

20. The discharge head as claimed in claim 18, with the following additional feature:
a. the outlet valve is formed from an elastic material and has a bulge which is directed upstream and in which a valve opening, which is able to be closed by valve lips, is provided such that, with increasing inlet-side positive pressure, the valve lips are increasingly pressed against one another by the positive pressure up to the attainment of an inlet-side limit pressure for positive pressure.

21. The discharge head as claimed in claim 1, with the following additional feature:
a. the discharge head is designed for the formation of drops, wherein the throttle device is designed for a limitation of the liquid flow, which leads to the formation of single drops, and not to the formation of a liquid jet, at the discharge opening.

22. The discharge head as claimed in claim 1, with the following additional feature:
a. the discharge opening is surrounded by a drop formation surface, preferably in the form of a spherical cap.

23. The discharge head as claimed in claim 1, with the following additional feature:
a. the housing of the discharge head comprises a first, integral base component, which comprises the coupling device for attachment to the liquid store, and a second, integral applicator component, which has the discharge opening and is penetrated by the outlet channel and is fastened to the base component, wherein the outlet valve is preferably positionally fixed between the base component and the applicator component.

24. A liquid dispenser for dispensing liquid, in particular for dispensing cosmetic or pharmaceutical liquids, with the following features:
a. the liquid dispenser has a discharge head with a discharge opening for dispensing of liquid into a surrounding atmosphere, and
b. the liquid dispenser has a liquid store, which is connected to a housing of the discharge head by way of a detachable coupling device or an integral formation, and
c. the discharge head is designed as claimed in claim 1.

25. The liquid dispenser as claimed in claim 24, with the following additional feature:
a. the liquid dispenser is designed in the form of a drop dispenser.

26. The liquid dispenser as claimed in claim 24, with the following additional feature:
a. the liquid store is designed in the form of a squeeze bottle or tube.

27. The liquid dispenser as claimed in claim 24, with the following additional feature:
a. an inner volume of the liquid store is less than 300 ml, preferably less than 100 ml, in particular preferably less than 50 ml.

28. The liquid dispenser as claimed in claim 24, with the following additional feature:
a. the liquid store is filled with a cosmetic or pharmaceutical liquid.
